(19) United States
(12) Patent Application Publication
(10) Pub. No.: US 2004/0019895 A1
(43) Pub. Date: Jan. 29, 2004

(54) Dynamic communication tuning apparatus, systems, and methods

(75) Inventor: Scott P. Dubal, Hillsboro, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/207,476

(22) Filed: Jul. 29, 2002

(51) Int. Cl. G06F 9/00; G06F 15/163; G06F 9/54

(52) U.S. Cl. 719/321

(57) ABSTRACT

An apparatus and system, in one embodiment to be used in a network controller, may include a driver module, a monitoring module, and an adjustment module. The monitoring module may be used to compare a value associated with a throughput indication for the driver module to a corresponding reference value. The adjustment module may then automatically adjust a parameter value associated with the driver module to provide a new parameter value that serves to increase the throughput performance of the driver module. An article may include data, which when accessed, results in a machine performing a method including comparing the value associated with a throughput indication for the driver module to a corresponding reference value, determining that the value associated with the throughput indication is less than the reference value, and then automatically adjusting a parameter value associated with the driver module to increase performance of the driver module.

### TECHNICAL FIELD

Embodiments of the invention relate generally to apparatus, systems, and methods for managing resources related to the transfer and/or communication of data.

### BACKGROUND INFORMATION

A computer network is a system of hardware and software that allows two or more computers to communicate with each other. Networks may be of several different kinds. For example, local area networks (“LANs”) connect computers within a work-group or department. There are also wide area networks (“WANs”) that connect nodes in different cities, states and countries. In a communications network, such as a LAN or WAN, a network adapter may be used to manage the transmission and reception of data on behalf of a computer, such as a desktop computer or a workstation.

Network adapters running under the Microsoft® Windows® Operating System (OS) environment typically have a device driver associated with their miniport instance. The device driver typically conforms to the Network Driver Interface Specification (NDIS), Version 5.0, 1998. The NDIS provides a Microsoft® Windows® device interface that enables a single Network Interface Card (NIC) to support multiple network protocols. Further information regarding Version 5.0 of the NDIS can be found at http://www-microsoft-com/hwdev/tech/network/ndis5-asp (to avoid inadvertent hyperlinks the periods in the preceding URL have been replaced by dashes).

An NDIS-compliant driver reads configuration parameters from values written into the system registry at the time the network adapter was installed in the system. For most network adapters, registry values are static and do not change unless the user physically modifies the registry. If the user changes these parameters without understanding their function, including how they affect driver performance, such modifications may operate to degrade the transmit and receive performance capability of the associated network adapter. For instance, manually changing the number of transmit and receive descriptors to relatively high values for a network adapter used on a Pentium® IV laptop system may severely restrict the transmit and receive throughput. On the other hand, making the same changes with respect to a network adapter on a Pentium® IV desktop system can dramatically increase performance. The differences may be due to various factors or combinations of factors, such as chipset errata, lack of physical or virtual memory, system bus speed/bandwidth, processor speed, etc. Thus, it may be desirable to provide a mechanism capable of tuning NDIS-compliant drivers for increased efficiency with respect to specific systems and their associated network adapters.

### BRIEF DESCRIPTION OF THE DRAWINGS

FIG. 1 is a block diagram of an apparatus, an article including a machine-accessible medium, and a system according to various embodiments of the invention; and

FIG. 2 is a flow chart illustrating a dynamic driver tuning method according to an embodiment of the invention.

### DETAILED DESCRIPTION OF THE EMBODIMENTS

In the following detailed description of various embodiments of the invention, reference is made to the accompanying drawings that form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. The following detailed description, therefore, is not to be taken in a limiting sense, and the scope of various embodiments of the invention is defined only by the appended claims, along with the full range of equivalents to which such claims are entitled.

As introduced above, the NDIS serves as a device driver model for network controllers under the Windows® OS (e.g., 1998, 2000, NT, ME, XP, etc.). This specification provides a common interface for network drivers under the OS, and it can be used with many different protocol stacks and applications. Therefore, if a driver is NDIS-compliant, it can interoperate with protocols or network file systems that are also NDIS-compliant.

In high-speed networks, such as an Ethernet network (see IEEE 802.3, 2000 Edition, IEEE Standard for Information Technology—Telecommunications and information exchange between systems—local and metropolitan area networks—specific requirements—Part 3: Carrier Sense Multiple Access with Collision Detection Access Method and Physical Layer Specifications, currently published at http://standards-ieee-org/getieee802/) (to avoid inadvertent hyperlinks the periods in the preceding URL has been replaced by a dash), an end-station receiving node, such as a PC or a server, can be inundated with a high rate of incoming data. Therefore, when such networks are used, it becomes imperative to operate as efficiently as possible.

To accommodate high-speed network operations, various embodiments of the invention may operate to automatically change registry parameters in a non-random manner, increasing the efficiency of communications using a “dynamic tuning” mechanism. For example, this solution may be implemented by acting to modify the operations of the Intel® PROMon utility supplied with Intel® PRO network adapters.

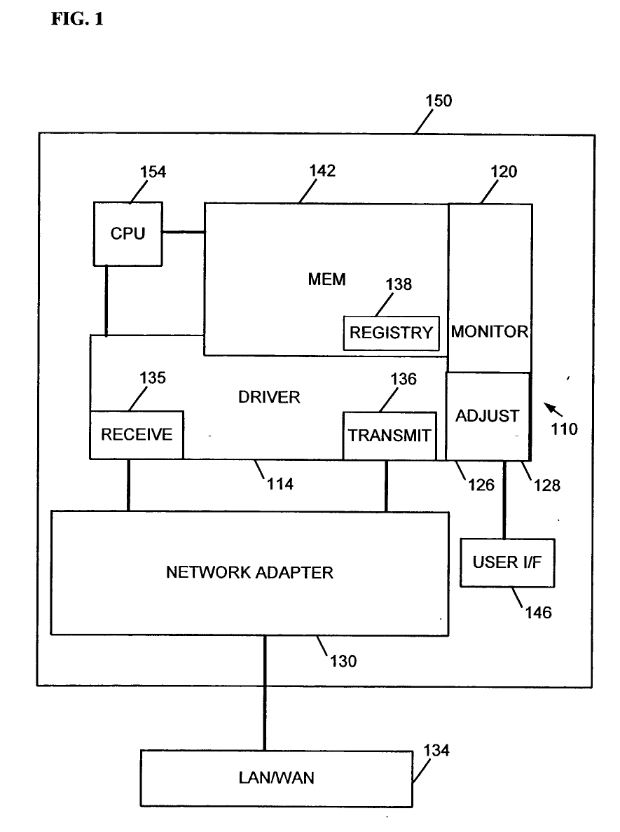

FIG. 1 is a block diagram of an apparatus, an article including a machine-accessible medium, and a system according to various embodiments of the invention. The apparatus 110 may include a driver module 114, a monitoring module 120, and an adjustment module 126. Depending on the design of the apparatus 110, the monitoring module 120 and the adjustment module 126 may both be included in a single software program module 128.

The driver module 120 may be used as an interface to a network adapter 130, such as an Intel® PRO/100+ network adapter, or a similar wired network adapter, or even a wireless network adapter, which may in turn be coupled to a network 134, such as a LAN or WAN, including the Internet. The driver module 120 may be designed to operate in accordance with the NDIS specification (i.e., the module 120 may be NDIS-compliant).

The monitoring module 120, capable of being communicatively coupled to the driver module 114, operates to compare the actual throughput achieved by the driver module 114 to a preselected reference performance value. The driver module 114 may include, in the form of registers or analog voltages, for example, a reception rate indicator 135 and a transmission rate indicator 136. Thus, the driver module 114 may be designed to maintain one or more values associated with corresponding throughput indications in one or more registers 135, 136. Each of the indicators or registers 135, 136 can be coupled to the monitoring module 120 so that actual receive and transmit throughput rates can be sensed, monitored, and compared with corresponding preselected reference performance values.

For example, if the network adapter 130 is expected to operate at a reception rate of 100 Megabits/second, then the actual reception rate may be degraded to a value of 90 Megabits/second due to network conditions, while the corresponding preselected reference performance value may be 80 Megabits/second. Thus a value (e.g., 90 Megabits/second) associated with the throughput indication (e.g., network adapter reception rate) is compared to the corresponding reference throughput value (e.g., 80 Megabits/second).

If a determination is made that the actual throughput indication value is less than the reference throughput value (e.g., the value associated with the throughput indication has fallen below 80 Megabits/second), the adjustment module 126, capable of being communicatively coupled to the monitoring module 120, responsively operates to automatically adjust one or more selected parameter values for the driver module 114. For example, if the actual reception rate falls below the reference throughput value of 80 Megabits/second, the parameter selected for adjustment may be the number of receive buffers allotted for use by the driver module 114. The monitoring module 120 may automatically respond by increasing the number of receive buffers up to some preselected limit. Of course, other parameters may be adjusted, and the monitoring module 120 may even be designed so as to select from different levels or tiers of parameters which may be adjusted, such as one tier having the most drastic effect on performance (both positive and negative), and another tier having a less dramatic effect, for example. Examples of changes made to parameters grouped within a tier might be: changing the default flow control parameters, turning on packet coalescing, and disabling intermediate drivers such as a virtual local area network (VLAN) driver. Standard NDIS parameters such as “Number of Transmit Descriptors” and “Number of Receive Descriptors” are also included among the parameter values which may be changed.

Parameters may be stored in a registry 138, as part of a memory 142. The memory 142, in turn, may be used to store any one, or all, of the modules 114, 120, and 126 as software program modules. As parameters in the registry 138 are changed to new values, these may also be stored in the registry 138. If desired, new parameter values may be indicated to a user of the apparatus 110 via the user interface module 146, which is capable of being communicatively coupled to the driver module 114 and/or the adjustment module 126. The user interface module 146 may include, or be coupled to a video display, an audio speaker, or other device which can communicate a change in the operation of the driver module 114 to the senses of a user of the apparatus 110.

Other embodiments of the invention may be realized by using the apparatus 110 to form a portion of a system. Thus, as shown in FIG. 1, in an alternative embodiment, a system 150 may include a driver module 114 capable of being communicatively coupled to a monitoring module 120 and an adjustment module 126, each operating as described previously. In addition, the system 150 may include a network adapter 130, such as an Ethernet network adapter module, and/or a wireless network adapter module capable of being communicatively coupled to the driver module 114.

The system 150 may also include a memory 142 communicatively coupled to a processor 152, such as may be used in any type of computer, such as a desktop computer, a palmtop computer, a workstation, or in a computer or controller embedded in an appliance, such as a video player device. The memory 142 may also be communicatively coupled to the driver module 114, and/or the network adapter 130. As mentioned previously, the memory 142 may include a registry 138 to store parameter values, including new values resulting from adjusting previously selected parameter values so as to permit the driver module 114 and/or the network adapter 130 to operate with increased efficiency as network conditions change, or as hardware and software are added to, and removed from the system 150.

The apparatus 110, the driver module 114, the monitoring module 120, the adjustment module 126, the software program module 128, the network adapter 130, the receive and transmit indicators 135, 136, the registry 138, the memory 142, the user interface 146, the system 150, and the processor 154 may all be characterized as “modules” herein. Such modules may include hardware circuitry, and/or a processor and/or memory circuits, software program modules, and/or firmware, and combinations thereof, as desired by the architect of the apparatus 110 and the system 150, and as appropriate for particular implementations of various embodiments of the invention.

One of many potential advantages that may be provided by some embodiments of the invention is that transmit and receive throughput of various driver modules, such as an Intel® PRO NDIS driver, for example, can be monitored (e.g., continuously or periodically) for performance degradation. If, for example, a modified version of the Intel® PROMon utility is used to accomplish the function of the monitoring module 120, and it is determined that performance has degraded to the point that one or more of the driver module 114 parameters needs to be adjusted, the monitoring module 120, via the user interface 146, might operate to warn the user of the imminent changes, the adjustment module 126 might make the changes to one or more NDIS parameters stored in the registry 138, and then the driver module 120 might be stopped and restarted so that the new parameter values can be read out of the registry 138.

Operating in this automated fashion, the need to expose a user to some type of parameter display, such as the “Advanced” page made available by the Intel® PROSet Graphical User Interface (GUI), may be eliminated. Currently, any user might be permitted to manually change driver module parameters affecting system throughput performance. However, by making use of various embodiments of the invention, these parameters may be automatically and dynamically tuned for performance, in concert with network conditions, so that such a display might no longer be needed. The result is that the user could be denied the ability to inadvertently degrade network adapter transmit and receive performance by changing the wrong parameters via the GUI.

It should be noted that some embodiments of the invention also may be designed to account for certain changes made to the system 150. For example, if a faster processor 154 and more memory 142 are added to the system 150, the monitoring module 120 may be designed to detect the changes and re-tune the driver module by adjusting parameters in the registry 138 to take advantage of the increased speed and larger memory pool. Other factors which may be considered for automated parameter adjustment include the amount of physical and virtual memory, system bus speed and bandwidth, etc.

It should also be understood that the apparatus and systems of various embodiments of the invention can be used in applications other than for computers, and other than for systems which include networked computers, and thus, embodiments of the invention are not to be so limited. The illustrations of an apparatus 110 and a system 150 are intended to provide a general understanding of the structure of various embodiments of the invention, and they are not intended to serve as a complete description of all the elements and features of apparatus and systems that might make use of the structures described herein.

Applications which may include the novel apparatus and systems of various embodiments of the invention include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, cellular telephones, personal computers, radios, video players, vehicles, and others.

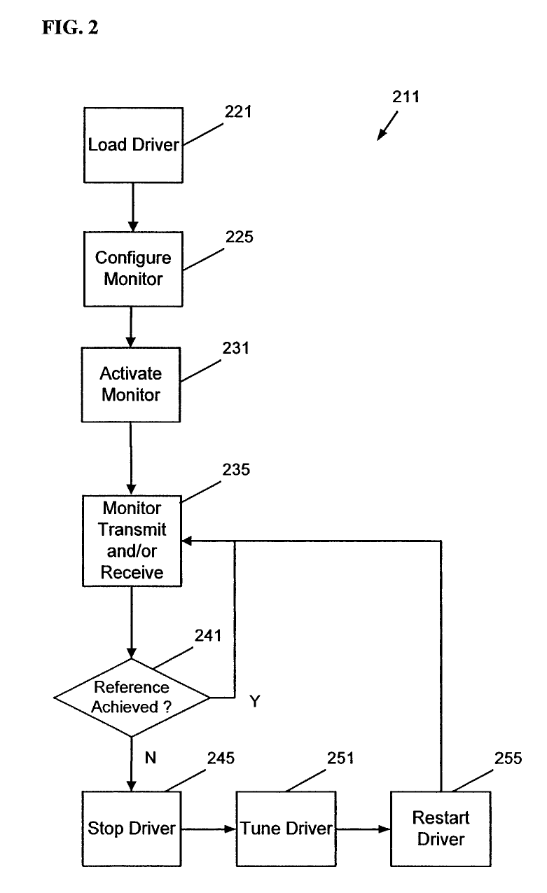

FIG. 2 is a flow chart illustrating a dynamic driver tuning method according to an embodiment of the invention. For example, in one embodiment, the method might be carried out using a modified version of an Intel® PRO network adapter and a correspondingly modified version of an Intel® PROMon utility to provide a mechanism for “dynamic tuning” of a driver module, such as an NDIS-compliant driver module.

Thus, a modified Intel® PRO network adapter and a correspondingly modified Intel® PROMon utility might operate as follows. First, an NDIS-compliant driver may be loaded on to a miniport instance, and the user might initiate operation by “clicking” on the PROMon Windows® tray icon to configure the PROMon utility to monitor network driver transmit and receive throughput rates. At this point, the PROMon utility may operate in the dynamic tuning mode while monitoring transmit and receive throughput rates. If the driver module achieves the expected wire speed, or some other level of performance above a preselected reference level, then the PROMon utility will continue to monitor the throughput rates. If the driver module fails to achieve the preselected reference performance level, the PROMon utility may act to stop the driver module data processing operations, autonomously adjust one or more relevant parameters, and then restart the driver module so that the new registry parameter(s) can be read and loaded into the driver module.

Therefore, the method 211 shown in FIG. 2 may begin by loading a driver module into a memory, such as a computer memory or a network adapter memory, at block 221. The method may continue with configuring the monitoring module at block 225. Configuration operations may include, for example, selecting one or more levels or tiers of parameter values associated with the driver module. Such parameter values may include the number of transmit and/or receiver buffers allotted to the driver module, a duplex parameter value, a speed parameter value, flow control defaults, enabling packet coalescing, and disabling intermediate drivers such as a VLAN driver. Each level may include similar or identical parameters, or the levels may be chosen so that each level is characterized by unique parameters which are not included in any other level. Such levels might be selected as a first level, including parameters having the most dramatic effect on driver module performance, and a second level, including parameters having a lesser effect, or even an indirect effect on driver module performance. Configuration may also include selecting specific throughput indicators to monitor, such as transmission and reception throughput rate indicators, which may be measured in bytes/second, a number of repeated characters, a number of checksum errors, etc.

The method 211 may continue with activating the monitoring module at block 231, monitoring the value associated with a throughput indication for the driver module, such as by using the monitoring module to monitor transmit and/or receive throughput indicators at block 235, and then determining whether the desired performance has been achieved at block 241. This may be accomplished, for example, by comparing a value associated with the actual throughput indication for a driver module to a corresponding reference throughput value.

If it is determined that the value associated with the actual throughput indication is less than the corresponding reference throughput value, a parameter value associated with the driver module may be automatically adjusted so as to provide a new value (in response to determining that the value associated with the throughput indication is less than the corresponding reference throughput value). Additional parameter values associated with the driver module may also be automatically adjusted in response to determining that the value associated with the throughput indication is less than the corresponding reference throughput value. Automatic, autonomous parameter adjustment may occur by de-activating the driver module so as to place the driver module in a non-operating state at block 245, tuning the driver at block 251 by selecting a new parameter value for storing in the registry, and waiting until the driver module is placed back into the operating state. The new parameter value(s) may then be read from the registry, and the driver module may be activated so as to place the driver module back into the operating state at block 255. Continual monitoring and automatic, autonomous adjustment of the driver module performance may be accomplished by repeating the activities noted for blocks 235, 241, 245, 251, and 255.

Thus, referring back to FIG. 1, it is now easily understood that another embodiment of the invention may include an article 150, such as a computer, a memory system, a magnetic or optical disk, some other storage device, and/or any type of electronic device or system, for example a network controller 150, comprising a machine-accessible medium such as a memory 142 (e.g., a memory including an electrical, optical, or electromagnetic conductor) having associated data 128 (e.g. computer program instructions), which when accessed, results in a machine performing such actions as comparing a value associated with a throughput indication for a driver module to a corresponding reference throughput value, determining that the value associated with the throughput indication is less than the corresponding reference throughput value, and autonomously adjusting a parameter value associated with the driver module so as to provide a new value (in response to determining that the value associated with the throughput indication is less than the corresponding reference throughput value). Autonomous adjustment may be accomplished using an adjustment module capable of being communicatively coupled to a monitoring module, as described above. Throughput indications may include, for example, transmission and/or reception throughput rates.

Other activities may include, for example, selecting a first level of parameter values including the parameter value associated with the driver module, and selecting a second level of parameter values including additional parameter values associated with the driver module, wherein the parameter value in the first level associated with the driver module is not included in the second level. As noted above, parameter values may include, but are not limited to, duplex parameter values, speed parameter values, or the number of buffers allocated to the driver module. The driver module may be de-activated and restarted (i.e., placed in a non-operating state, and then placed in an operating state) so that new parameter values can be read from the registry and loaded into the driver module.

Many variations of the methods described herein are possible. For example, a method of adjusting a network driver according to an alternative embodiment may include accessing data identifying measured performance of the network driver, and, based at least on the accessed data identifying measured performance, changing at least one parameter that affects operation of the network driver. The method may also include accessing data identifying system resources, wherein changing the at least one parameter comprises changing the at least one parameter based at least on the data identifying system resources. In addition, the method may include selecting the at least one parameter of the network driver, as well as repeatedly changing at least one parameter of the network driver until measured performance reaches a threshold.

The network driver may comprise a Microsoft® Windows® operating system NDIS compliant driver, and the measured performance may include at least one of a measure of throughput, a measure of missed packets, a bit error rate, a rate of packet transmission, and/or a rate of packet reception. Examples of system resources include available memory and/or processor speed.

Although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description.

The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In addition, in the foregoing Detailed Description of Embodiments of the Invention, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. An apparatus, comprising:
a driver module;
a monitoring module capable of being communicatively coupled to the driver module, the monitoring module to compare a value associated with a throughput indication for the driver module to a corresponding reference throughput value; and
an adjustment module capable of being communicatively coupled to the monitoring module, the adjustment module to adjust a parameter value associated with the driver module to provide a new value in response to the monitoring module providing an indication that the value associated with the throughput indication is less than the corresponding reference throughput value.

2. The apparatus of claim 1, wherein the monitoring module and the adjustment module are included in a single software program.

3. The apparatus of claim 1, further comprising:
a registry to store the new value.

4. The apparatus of claim 1, wherein the driver module is capable of operating in compliance with a network driver interface specification.

5. The apparatus of claim 4, wherein the network driver interface specification is a Microsoft® Windows® operating system Network Driver Interface Specification (NDIS).

6. The apparatus of claim 1, further comprising:
a user interface module to provide an indication of the new value.

7. The apparatus of claim 1, further comprising:
a transmission throughput rate indicator.

8. The apparatus of claim 7, further comprising:
a reception throughput rate indicator.

9. A system, comprising:
a Microsoft® Windows® operating system Network Driver Interface Specification (NDIS) compliant driver module;
a monitoring module capable of being communicatively coupled to the driver module, the monitoring module to compare a value associated with a throughput indication for the driver module to a corresponding reference throughput value;
an adjustment module capable of being communicatively coupled to the monitoring module, the adjustment module to adjust a parameter value associated with the driver module to provide a new value in response to the monitoring module providing an indication that the value associated with the throughput indication is less than the corresponding reference throughput value; and
a network adapter module capable of being communicatively coupled to the driver module.

10. The system of claim 9, further comprising:
a memory including a registry to store the new value.

11. The system of claim 9, wherein the driver module maintains the value associated with the throughput indication in a register.

12. The system of claim 9, further comprising:
a memory capable of being communicatively coupled to the wireless network adapter; and
a processor capable of being communicatively coupled to the memory.

13. A method, comprising:
comparing a value associated with a throughput indication for a driver module with a corresponding reference throughput value;
determining that the value associated with the throughput indication is less than the corresponding reference throughput value; and
adjusting, using an adjustment module capable of being communicatively coupled to a monitoring module, a parameter value associated with the driver module so as to provide a new value in response to determining that the value associated with the throughput indication is less than the corresponding reference throughput value.

14. The method of claim 13, further comprising:
activating the driver module so as to place the driver module in an operating state.

15. The method of claim 14, further comprising:
waiting until the driver module is placed in the operating state.

16. The method of claim 13, further comprising:
adjusting an additional parameter value associated with the driver module in response to determining that the value associated with the throughput indication is less than the corresponding reference throughput value.

17. The method of claim 13, further comprising:
reading the new value from a registry.

18. The method of claim 13, further comprising:
monitoring, using the monitoring module, the value associated with the throughput indication for the driver module .

19. The method of claim 13, wherein the throughput indication is an indication of a transmission throughput rate.

20. An article comprising a machine-accessible medium having associated data, wherein the data, when accessed, results in a machine performing:
comparing a value associated with a throughput indication for a driver module to a corresponding reference throughput value;
determining that the value associated with the throughput indication is less than the corresponding reference throughput value; and
adjusting, using an adjustment module capable of being communicatively coupled to a monitoring module, a parameter value associated with the driver module so as to provide a new value in response to determining that the value associated with the throughput indication is less than the corresponding reference throughput value.

21. The article of claim 20, wherein the machine-accessible medium further includes data, which when accessed by the machine, results in the machine performing:
selecting a first level of parameter values including the parameter value associated with the driver module; and
selecting a second level of parameter values including an additional parameter value associated with the driver module, and not including the parameter value associated with the driver module.

22. The article of claim 20, wherein the parameter value is a duplex parameter value.

23. The article of claim 20, wherein the parameter value is a speed parameter value.

24. The article of claim 20, wherein the throughput indication is an indication of a reception throughput rate.

25. The article of claim 20, wherein the parameter value associated with the driver module is a number of buffers.

26. The article of claim 20, wherein the machine-accessible medium further includes data, which when accessed by the machine, results in the machine performing:
de-activating the driver module so as to place the driver module in a non-operating state.

27. A method of adjusting a network driver, the method comprising:
accessing data identifying measured performance of the network driver; and
based at least on the accessed data identifying measured performance, changing at least one parameter that affects operation of the network driver.

28. The method of claim 27, wherein the network driver comprises a Microsoft® Windows® operating system Network Driver Interface Specification (NDIS) compliant driver.

29. The method of claim 27, wherein the measured performance comprises at least one of a measure of throughput, a measure of missed packets, a bit error rate, a rate of packet transmission, and a rate of packet reception.

30. The method of claim 27, further comprising accessing data identifying system resources, wherein changing the at least one parameter comprises changing the at least one parameter based at least on the data identifying system resources.

31. The method of claim 30, wherein the system resources comprise at least one of available memory and processor speed.

32. The method of claim 27, further comprising selecting the at least one parameter of the network driver.

33. The method of claim 27, further comprising repeatedly changing at least one parameter of the network driver until measured performance reaches a threshold.
